(19) United States
(12) Patent Application Publication
(10) Pub. No.: US 2012/0257048 A1
(43) Pub. Date: Oct. 11, 2012

(54) VIDEO INFORMATION PROCESSING METHOD AND VIDEO INFORMATION PROCESSING APPARATUS

(75) Inventors: Mahoro Anabuki, Yokohama-shi (JP); Yasuo Katano, Kawasaki-shi (JP)

(73) Assignee: CANON KABUSHIKI KAISHA, Tokyo (JP)

(21) Appl. No.: 13/516,152

(22) PCT Filed: Dec. 7, 2010
(86) PCT No.: PCT/JP2010/007106

§ 371 Date: Jun. 14, 2012

(30) Foreign Application Priority Data
Dec. 17, 2009 (JP) 2009-286894

(51) Int. Cl. H04N 7/18

(52) U.S. Cl. 348/135; 348/E07.085

(57) ABSTRACT

It is desired to check a difference of a given movement performed on different date.

An action of a person in a real space is recognized for each of a plurality of videos of the real space captured on different dates. An amount of movement in each of the plurality of captured videos is analyzed. Based on the amount of movement, a plurality of comparison-target videos are extracted from a plurality of videos including the given action of the person. Each of the comparison-target videos is reconstructed in a three-dimensional virtual space so that video information is generated that indicates a difference between the person's action in each of the plurality of comparison-target videos and the person's action in another comparison-target video. The generated video information is displayed.

### TECHNICAL FIELD

The present invention relates to a method for visualizing a difference between a plurality of captured videos of a human action and to an apparatus for the same.

### BACKGROUND ART

Captured videos are utilized in rehabilitation (hereinafter, simply referred to as rehab) of people physically challenged due to sickness or injury. More specifically, videos of the physically challenged people performing a given rehab program or a given daily action are regularly captured. The videos captured on different dates are then displayed continuously or in parallel, so that a difference in a posture during the action or in speed of the action is explicitly visualized. Visualization of the difference in the action is useful for the physically challenged people to check an effect of the rehab.

To visualize the difference in the action, videos of the same action captured under the same condition on different dates are needed. Accordingly, the videos may be captured in an environment allowing the physically challenged people to perform the same action under the same condition on different dates. Since the physically challenged people requiring the rehab have difficulty capturing videos of their action by themselves, they generally capture the videos with experts, such as therapists, after setting a schedule with the experts. However, the physically challenged people performing the rehab at their homes have difficulty preparing such videos.

Patent Literature 1 discloses a technique for realizing high-speed retrieval of captured videos of a specific scene by analyzing and categorizing captured videos and recording the captured videos for each category. With the technique, the captured videos can be categorized for each action performed under the same condition. However, even if the captured videos are categorized, only experts, such as therapists, can identify which of the categorized videos is useful to understand a progress of their patients. Accordingly, selecting comparison-target videos from the categorized videos is unfortunately difficult.

### CITATION LIST

### Patent Literature

PTL 1: Japanese Patent Laid-Open No. 2004-145564

### SUMMARY OF INVENTION

In the present invention, videos are displayed that help users to check a difference in their movement of a given action.

In accordance with a first aspect of the present invention, a video information processing apparatus includes: a recognizing unit configured to recognize an event in a real space in each of a plurality of captured videos of the real space; a categorizing unit configured to attach metadata regarding each recognized event to the corresponding captured video to categorize the captured video; a retrieving unit configured to retrieve, based on the attached metadata, a plurality of captured videos of a given event from the categorized captured videos; an analyzing unit configured to analyze a feature of a movement in each of the plurality of retrieved videos; and a selecting unit configured to select, based on a difference between the features of the movement analyzed for the retrieved videos, two or more videos from the retrieved videos.

In accordance with another aspect of the present invention, a video information processing apparatus includes: an analyzing unit configured to analyze a feature of a movement in each of a plurality of captured videos of a real space; a categorizing unit configured to attach metadata regarding each analyzed feature of the movement to the corresponding captured video to categorize the captured video; a retrieving unit configured to retrieve a plurality of captured videos based on the attached metadata; a recognizing unit configured to recognize an event in the real space in each of the plurality of retrieved videos; and a selecting unit configured to select, based on the event recognized in each of the retrieved videos, two or more captured videos from the retrieved videos.

In accordance with still another aspect of the present invention, a video information processing method includes the steps of: recognizing an event in a real space in each of a plurality of captured videos of the real space; attaching metadata regarding each recognized event to the corresponding captured video to categorize the captured video; retrieving, based on the metadata, a plurality of captured videos of a given event from the categorized captured videos; analyzing a feature of a movement in each of the plurality of retrieved videos; selecting, based on a difference between the features of the movement analyzed for the retrieved videos, two or more videos from the retrieved videos; and generating, based on the selected videos, video information to be displayed.

In accordance with a further aspect of the present invention, a video information processing method includes the steps of:

analyzing a feature of a movement in each of a plurality of captured videos of a real space; attaching metadata regarding each analyze feature of the movement to the corresponding captured video to categorize the captured video; retrieving a plurality of captured videos based on the attached metadata; recognizing an event in the real space in each of the plurality of retrieved videos; selecting, based on the event recognized in each of the retrieved videos, two or more captured videos from the retrieved videos; and generating, based on the selected videos, video information to be displayed.

In accordance with a still further aspect of the present invention, a program causes a computer to execute each step of one of the video information processing methods described above.

In accordance with another aspect of the present invention, a recording medium stores a program causing a computer to execute each step of one of the video information processing methods described above.

Further features of the present invention will be apparent from the following description of exemplary embodiments with reference to the attached drawings.

### BRIEF DESCRIPTION OF DRAWINGS

FIG. 1 is a block diagram illustrating a configuration of a video information processing apparatus according to a first exemplary embodiment of the present invention.

FIG. 2 is a flowchart illustrating processing of the video information processing apparatus according to the first exemplary embodiment of the present invention.

FIG. 3 is a diagram illustrating an example of generating video information from selected videos in accordance with the first exemplary embodiment of the present invention.

FIG. 4 is a block diagram illustrating a configuration of a video information processing apparatus according to a second exemplary embodiment of the present invention.

FIG. 5 is a flowchart illustrating processing of the video information processing apparatus according to the second exemplary embodiment of the present invention.

FIG. 6 is a diagram illustrating examples of captured videos in accordance with the second exemplary embodiment of the present invention.

### DESCRIPTION OF EMBODIMENTS

A preferred embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

Exemplary Embodiments of the present invention will now be described in detail below with reference to the accompanying drawings.

### First Exemplary Embodiment

### Overview

A configuration and processing of a video processing apparatus according to a first exemplary embodiment will be described below with reference to the accompanying drawings.

### Configuration 100

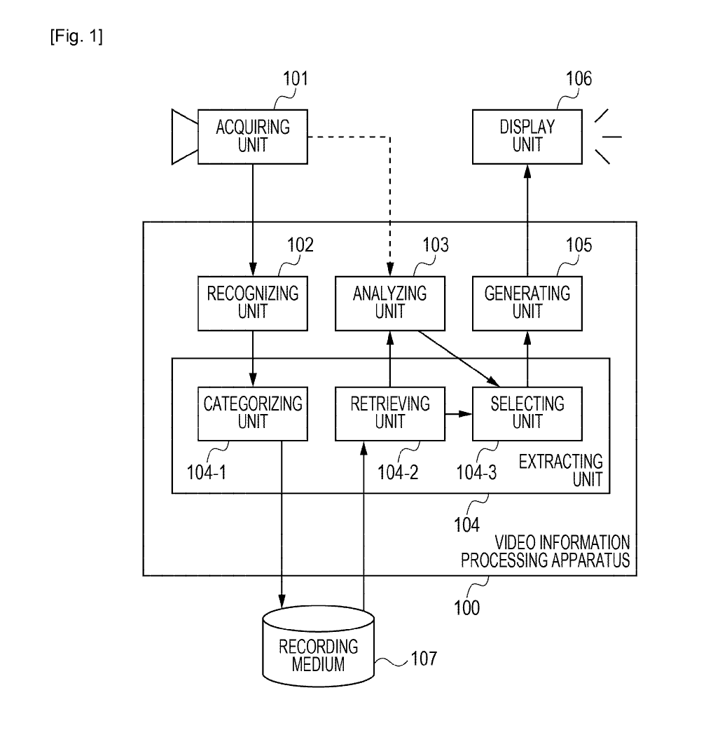

FIG. 1 is a diagram illustrating an overview of a video information processing apparatus 100 according to the first exemplary embodiment. As illustrated in FIG. 1, the video information processing apparatus 100 includes an acquiring unit 101, a recognizing unit 102, an analyzing unit 103, an extracting unit 104, a generating unit 105, and a display unit 106. The extracting unit 104 includes a categorizing unit 104-1, a retrieving unit 104-2, and a selecting unit 104-3.

The acquiring unit 101 acquires a captured video. For example, a camera installed at a general home and continuously capturing a video of the home space serves as the acquiring unit 101. As metadata, the acquiring unit 101 also acquires capturing information, such as parameters of the camera and shooting date/time. Other than the camera, sensors, such as a microphone, a human sensor, and a pressure sensor installed on a floor, may serve as the acquiring unit 101. The acquired video and the metadata are output to the recognizing unit 102.

After receiving the captured video and the metadata from the acquiring unit 101, the recognizing unit 102 recognizes an event regarding a person or an object included in the captured video. For example, recognition processing includes human recognition processing, face recognition processing, facial expression recognition processing, human or object position/posture recognition processing, human action recognition processing, and general object recognition processing. Information on the recognized event, the captured video, and the metadata are sent to the categorizing unit 104-1.

The categorizing unit 104-1 categorizes the captured video into a corresponding category based on the recognized event and the metadata. More than one category is prepared beforehand. For example, when a video includes an event “walking” of “Mr. A” recognized from the action and human recognition processing and has the metadata indicating “captured in the morning”, the video is categorized into a category “move” or “Mr. A in the morning”. The determined category serving as new metadata is recorded on a recording medium 107.

Based on the metadata, the retrieving unit 104-2 retrieves and extracts videos of a check-target event from the categorized videos. For example, the retrieving unit 104-2 may retrieve captured videos having the metadata “in the morning” attached by the acquiring unit 101 or the metadata “move” attached by the categorizing unit 104-1. The extracted videos and the metadata are sent to the analyzing unit 103 and the selecting unit 104-3.

The analyzing unit 103 quantitatively analyzes each of the videos sent from the retrieving unit 104-2. The recognizing unit 102 recognizes an event (who, what, which, and when) in the captured videos, whereas the analyzing unit 103 analyzes details of a movement (how) in the captured videos. For example, the analyzing unit 103 analyzes an angle of an arm joint of a person in the captured videos, a frequency of a walking movement, a height of lifted feet, and a walking speed. The analysis result is sent to the selecting unit 104-3.

The selecting unit 104-3 selects a plurality of comparable videos based on the metadata and the analysis result. For example, the selecting unit 104-3 selects two comparable videos from the retrieved videos having the specified metadata. The selected videos are sent to the generating unit 105.

The generating unit 105 generates video information explicitly indicating a difference in the action included in the selected videos. For example, the generating unit 105 generates a video by superimposing corresponding frames of the two selected videos using affine transformation so that a movement of the right foot of a subject is displayed at the same position. The generating unit 105 may also highlight the displayed right foot. Additionally, the generating unit 105 may generate a threedimensionally reconstructed video. The generated video information is sent to the display unit 106. In addition, the generating unit 105 may display the metadata of the two selected videos in parallel.

The display unit 106 displays the generated video information on a display.

The video information processing apparatus 100 according to this exemplary embodiment has the foregoing configuration.

### Processing 1

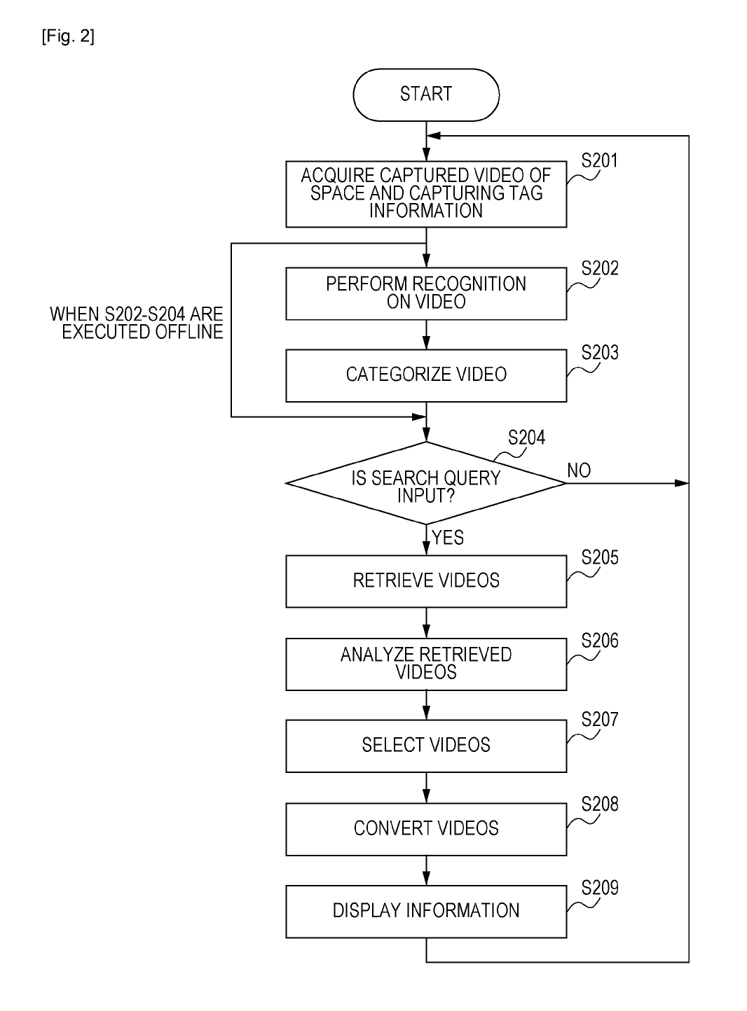

Processing executed by the video information processing apparatus 100 according to this exemplary embodiment will now be described with reference to a flowchart of FIG. 2. A program code according to the flowchart is stored in a memory, such as a random access memory (RAM) or a read-only memory (ROM), in the video information processing apparatus 100 according to this exemplary embodiment, and is read out and executed by a central processing unit (CPU) or a microprocessing unit (MPU). Processing regarding transmission and reception of data may be executed directly or via a network.

### Acquisition

In STEP S201, the acquiring unit 101 acquires a captured video of a real space.

For example, a camera installed at a general home continuously captures a video of the home space. The camera may be installed on a ceiling or a wall. The camera may be fixed to or included in furniture and fixture, such as a floor, a table, and a television. The camera attached to a robot or a person may move in the space. The camera may use a wide-angle lens to capture a video of the whole space. Parameters of the camera, such as a pan tilt parameter and a zoom parameter, may be fixed or variable. The video of the space may be captured from a plurality of viewpoints with a plurality of cameras.

The acquiring unit 101 also acquires capturing information serving as metadata. For example, the capturing information includes parameters of the camera and shooting date/time. The acquiring unit 101 may also acquire the metadata from sensors other than the camera. For example, the acquiring unit 101 may acquire audio data collected by a microphone, human presence/absence information detected by a human sensor, and floor pressure distribution information measured by a pressure sensor.

The acquired video and the metadata are output to the recognizing unit 102. The process then proceeds to STEP S202.

### Recognition

In STEP S202, after receiving the captured video and the metadata from the acquiring unit 101, the recognizing unit 102 qualitatively recognizes an event regarding a person or an object in the captured video.

For example, the recognizing unit 102 executes recognition processing, such as human recognition processing, face recognition processing, facial expression recognition processing, human or object position/posture recognition processing, human action recognition processing, and general object recognition processing. The recognition processing is not limited to one kind but a plurality of kinds of the recognition processing may be executed in combination.

In the recognition processing, the metadata output from the acquiring unit 101 may be utilized as needed. For example, audio data acquired from a microphone may be utilized as the metadata.

The recognizing unit 102 may be unable to execute the recognition processing using the captured video received from the acquiring unit 101 because duration of the video is short. In such a case, the recognizing unit 102 may store the received video and then the process returns to STEP S201. These steps may be repeated until the captured video sufficiently long enough for the recognition processing is accumulated. Recognition processing disclosed in U.S. Patent Laid-Open No. 2007/0237387 may be utilized.

Information on the recognized event, the captured video, and the metadata are sent to the categorizing unit 104-1. The process then proceeds to STEP S203.

### Categorization

In STEP S203, based on the recognized event and the metadata, the categorizing unit 104-1 categorizes the captured video into corresponding one or more of a plurality of prepared categories.

The categories are regarding events (what, who, which, when, and where) that can visualize an effect of rehab on a person. For example, when a video includes an event “walking” of “Mr. A” recognized from the action and human recognition processing and has metadata “captured in the morning”, the video is categorized into a category “move” or “Mr. A in the morning”. Experts may input the categories beforehand based on their knowledge.

Not all of the captured videos received from the recognizing unit 102 are categorized into the categories. Alternatively, the videos belonging to none of the categories may be collectively put into a category “others”.

For example, categorization processing for a captured video including a plurality of people will now be described. Simply based on human recognition results “Mr. A” and “Mr. B” and a human action recognition result “walking”, it is difficult to decide which of categories “walking of Mr. A” and “walking of Mr. B” into which the video is categorized. In such a case, with reference to positions of “Mr. A” and “Mr. B” in the video determined by the human recognition processing and a position in the video where “walking” is determined by the action recognition processing, the categorizing unit 104-1 selects one of the categories “walking of Mr. A” and “walking of Mr. B” for the video.

At this time, the whole video may be put into the category. Alternatively, a part of the video corresponding to the category may be clipped and categorized after undergoing partial hiding processing. The video may be categorized with reference to one of the recognition results. For example, a captured video having metadata “fall” resulting from the action recognition processing may be categorized into a category “fall” regardless of other recognition results and metadata.

The event and the category do not necessarily have one-to-one correspondence. A captured video having a human recognition result “Mr. A”, an action recognition result “walking”, and metadata “in the morning” and another captured video having a human recognition result “Mr. B”, an action recognition result “move on wheelchair”, and metadata “in the morning” may be categorized into a category “move of Mr. A and Mr. B in the morning”. In addition, the captured video having the human recognition result “Mr. A”, the action recognition result “walking”, and the metadata “in the morning” may be categorized into two categories “walking of Mr. A” and “Mr. A in the morning”.

The determined category serving as new metadata is recorded on the recording medium 107. The process then proceeds to STEP S204.

The captured videos may be recorded as separated files for each of the categories. Alternatively, the captured videos may be recorded as one file and a pointer for pointing the captured video attached with the metadata may be recorded in a different file. Those recording methods may be used in combination. For example, captured videos categorized into the same date may be recorded in one file and pointers pointing the respective videos may be recorded in another file prepared for each date. The captured videos may be recorded in a device of the recording medium 107, such as a hard disk drive (HDD), or on the recording medium 107 of a remote server connected to the video information processing apparatus 100 via a network.

### Retrieval

In STEP S204, the retrieving unit 104-2 determines whether an event query for retrieving captured videos is input. For example, the event query may be input through a keyboard and a button by a user or automatically input in accordance with a periodical schedule. An expert, such as a therapist, may remotely input the event query. Additionally, the metadata acquired in STEP S201 or S202 may be input.

If it is determined that the event query is input, the process proceeds to STEP S205. Otherwise, the process returns to STEP S201.

In STEP S205, the retrieving unit 104-2 retrieves and extracts, based on the input metadata, the categorized videos including the event to be checked. For example, captured videos having the metadata “in the morning” attached by the acquiring unit 101 may be retrieved or captured videos having the metadata “move” attached by the categorizing unit 104-1 may be retrieved. The extracted videos and the metadata are sent to the analyzing unit 103 and the selecting unit 104-3.

In response to inputting of the event query, such as the metadata, from outside, the retrieving unit 104-2 extracts captured videos corresponding to the metadata from the recorded videos. For example, videos captured between one day (present) and 30 days before that day (past) are subjected to the retrieval. In this way, the selecting unit 104-3 can select the captured videos allowing a user to know a progress of rehab during past 30 days.

The extracted videos and the corresponding metadata are sent to the analyzing unit 103 and the selecting unit 104-3.

### Analysis

In STEP S206, the analyzing unit 103 quantitatively analyzes each of the retrieved videos sent from the retrieving unit 104-2. The recognizing unit 102 recognizes an event (what) in the captured videos, whereas the analyzing unit 103 analyzes details (how) of an action in the captured videos.

For example, the analyzing unit 103 executes an analysis on each of the videos to measure features of the action, such as an angle of an arm joint of a person in the captured video, a frequency of a walking action, and a height of lifted feet. More specifically, after recognizing each individual body part of the person, the analyzing unit 103 quantitatively analyzes a relative change in positions and postures of the parts in the video. As an amount of the action, the analyzing unit 103 calculates the features of the action, such as the angle of the joint in a real space, the action frequency, and the action amplitude.

For example, the analyzing unit 103 utilizes a background subtraction technique to clip a subject, i.e., a person newly appearing in the captured video. The analyzing unit 103 then calculates a shape and a size of the clipped subject in the real space based on the size of the captured video.

When the acquiring unit 101 includes a stereo camera and the analyzing unit 103 acquires a stereo video, for example, the analyzing unit 103 calculates a distance to a subject in a screen based on available stereo video processing to determine a path and a speed of movement of the subject.

When the analyzing unit 103 analyzes, for example, a movement speed X m/s of the subject, the analyzing unit 103 executes the analysis processing while continuously receiving the captured video from the acquiring unit 101.

Many methods are available for analytically calculating the three-dimensional shape and position/posture of a person or an object included in the captured video in the real space. The analyzing unit 103 utilizes such available techniques to perform a spatial video analysis of the person (i.e., the subject) included in each video. Contents of the quantitative video analysis are set beforehand based on knowledge of experts and types of rehab.

The analysis result is sent to the selecting unit 104-3. The process then proceeds to STEP S207.

### Selection

In STEP S207, based on the metadata and the analysis result, the selecting unit 104-3 selects a plurality of comparable videos from the retrieved videos having the input metadata.

More specifically, the selecting unit 104-3 compares the analysis results of the walking action in the captured videos received from the analyzing unit 103. Based on a given criterion, the selecting unit 104-3 selects two similar or dissimilar videos (quantitatively, having a value smaller than or equal to a predetermined threshold or a value larger than or equal to another predetermined threshold).

For example, the selecting unit 104-3 can extract comparison-target videos by selecting captured videos having a movement-speed difference smaller than a predetermined threshold or a movement-speed difference larger than another predetermined threshold. Alternatively, the selecting unit 104-3 can extract comparison-target videos by selecting captured videos having an action-trajectory difference larger than a predetermined threshold or an action-trajectory difference smaller than another predetermined threshold.

For example, the action trajectories can be compared by comparing videos having a small action-speed difference but a large action-trajectory difference. At this time, the selected videos preferably have the action trajectories as different as possible. For example, the action speeds can be compared by comparing videos having a large action-speed difference but a small action-trajectory difference. At this time, the selected videos preferably have the action trajectories as similar as possible.

For example, the selecting unit 104-3 selects videos with a feet-lifting-height difference larger than or equal to a predetermined level and a movement-speed difference smaller than another predetermined level. Although two videos are selected here, three or more videos may be selected. That is, the comparison-target videos may be selected from three or more time points instead of two.

The threshold is not necessarily used. For example, the selecting unit 104-3 may select two captured videos having the largest action-speed difference or the largest action-trajectory difference.

Additionally, the selecting unit 104-3 may select two videos captured on different dates with reference to the metadata of shooting date/time attached to the captured videos. A user may specify retrieval-target dates beforehand so that videos subjected to recognition and analysis are narrowed down, whereby this setting may be realized.

The selected videos are sent to the generating unit 105. The process then proceeds to STEP S208.

### Generation

In STEP S208, the generating unit 105 generates video information explicitly indicating a difference in the action from the selected videos.

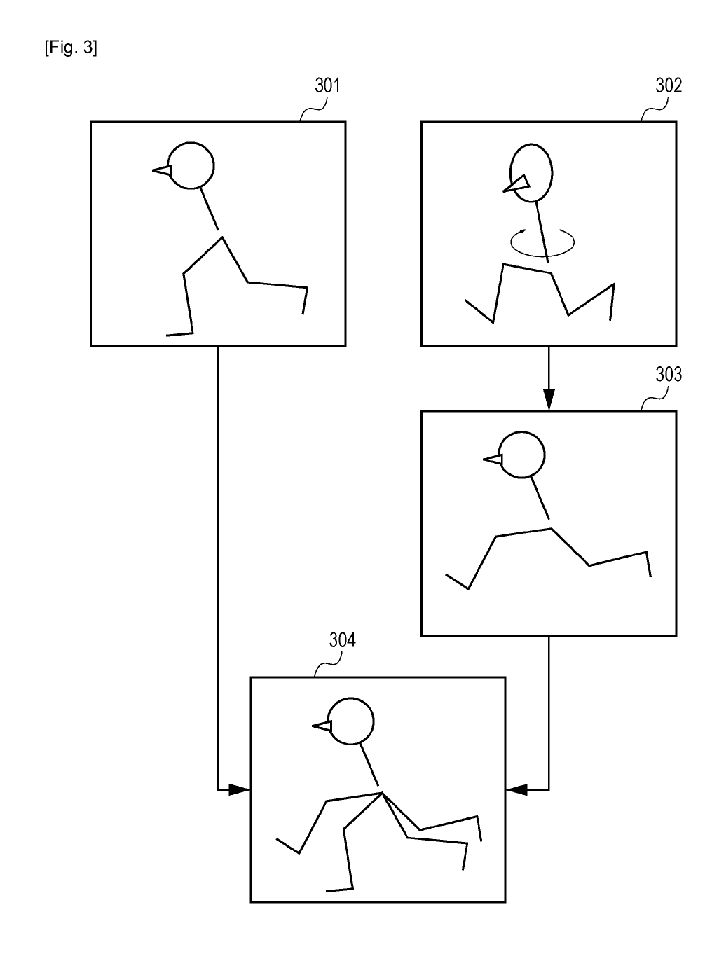

FIG. 3 illustrates an example of generating the video information from the selected videos. For example, the generating unit 105 performs affine transformation on each frame of a captured video 302 so that an action of a right foot is displayed at the same position in two captured videos 301 and 302 selected by the selecting unit 104-3. The generating unit 105 then superimposes the transformed video 303 on the video 301 to generate a video 304. In this way, weight movement on a left foot and weight movement in walking are visualized based on a difference in movement of the left foot and amplitude of movement of a lumbar joint. Alternatively, the generating unit 105 normalizes each frame of the two videos so that start points of the walking action and the scale of the videos match. The generating unit 105 then displays the generated videos in parallel or continuously. In this way, the user can compare the difference in the walking speed and the walking path. The video information generation method is not limited to the examples described here. A focused region may be highlighted, clipped, or annotated. Additionally, actions included in two captured videos may be integrated into a video reconstructing the integrated action in a three-dimensional space using three-dimensional reconstruction technique. The generating unit 105 may generate a video so that the two videos are arranged side by side. The generated video information is not limited to image information and information other than the image information may be generated. For example, the action speed may be visualized as values or graphs.

To allow users to confirm the comparison-target videos, the generating unit 105 may generate video information attached with information on the comparison targets. For example, the generating unit 105 generates video information attached with information on shooting dates of the two captured videos or a difference between the analysis results.

The generated video information is sent to the display unit 106. The process then proceeds to STEP S209.

### Display

In STEP S209, the display unit 106 displays the generated video information, for example, on a display. The process then returns to STEP S201.

Through the foregoing processing, the video information processing apparatus 100 can extract videos including a given action performed under the same condition from captured videos and select a combination of videos suitably used in visualization of a difference in the action.

### Second Exemplary Embodiment

In the first exemplary embodiment, various actions recorded in captured videos are categorized based on a qualitative criterion and a difference in an action of the same category is compared based on a quantitative criterion, whereby a plurality of captured videos are selected. In contrast, in a second exemplary embodiment, the various actions recorded in the captured videos are categorized based on the quantitative criterion and the difference in the action of the same category is compared based on the qualitative criterion, whereby the plurality of captured videos are selected.

A configuration and processing of a video information processing apparatus according to the second exemplary embodiment will be described below with reference to the accompanying drawings.

### Configuration 400

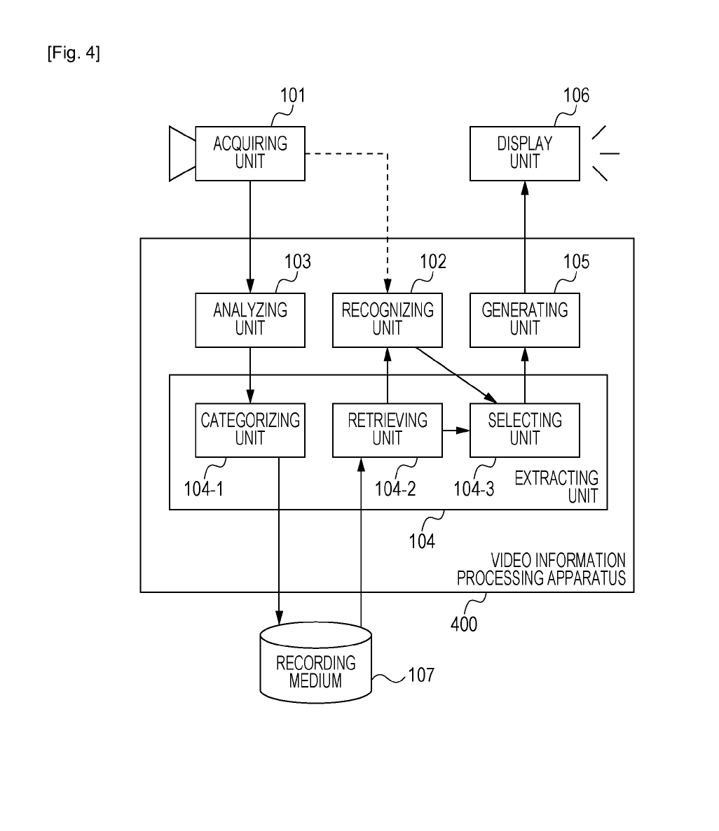

FIG. 4 is a diagram illustrating an overview of a video information processing apparatus 400 according to this exemplary embodiment. As illustrated in FIG. 4, the video information processing apparatus 400 includes an acquiring unit 101, a recognizing unit 102, an analyzing unit 103, an extracting unit 104, a generating unit 105, and a display unit 106. The extracting unit 104 includes a categorizing unit 104-1, a retrieving unit 104-2, and a selecting unit 104-3. Most of the configuration is similar to that of the video information processing apparatus 100 illustrated in FIG. 1. The similar parts are attached with like reference characters and a detailed description regarding the overlapping parts is omitted below.

The acquiring unit 101 acquires a captured video. The acquiring unit 101 also acquires, as metadata, information regarding a space where the video is captured. The captured video and the metadata acquired by the acquiring unit 101 are sent to the analyzing unit 103.

After receiving the captured video and the metadata output from the acquiring unit 101, the analyzing unit 103 analyzes the captured video. The video analysis result and the metadata are sent to the categorizing unit 104-1.

The categorizing unit 104-1 categorizes the captured video into one or more of a plurality of prepared categories based on the video analysis result and the metadata. The determined category serving as new metadata is recorded on a recording medium 107.

Based on specified metadata, the retrieving unit 104-2 retrieves and extracts videos including an event to be checked from the categorized videos. The extracted videos and the metadata are sent to the recognizing unit 102 and the selecting unit 104-3.

After receiving the retrieved videos and the metadata, the recognizing unit 102 recognizes an event regarding a person or an object included in the retrieved videos. Information on the recognized event, the retrieved videos, and the metadata are sent to the selecting unit 104-3.

The selecting unit 104-3 selects a plurality of comparable videos based on the metadata and the recognition result. The selected videos are sent to the generating unit 105.

The generating unit 105 generates video information for explicitly visualizing a difference in an action included in the videos selected by the selecting unit 104-3. The generated video information is sent to the display unit 106.

The display unit 106 displays the video information generated by the generating unit 105 to an observer through a display, for example.

The video information processing apparatus 400 according to this exemplary embodiment has the foregoing configuration.

### Processing 2

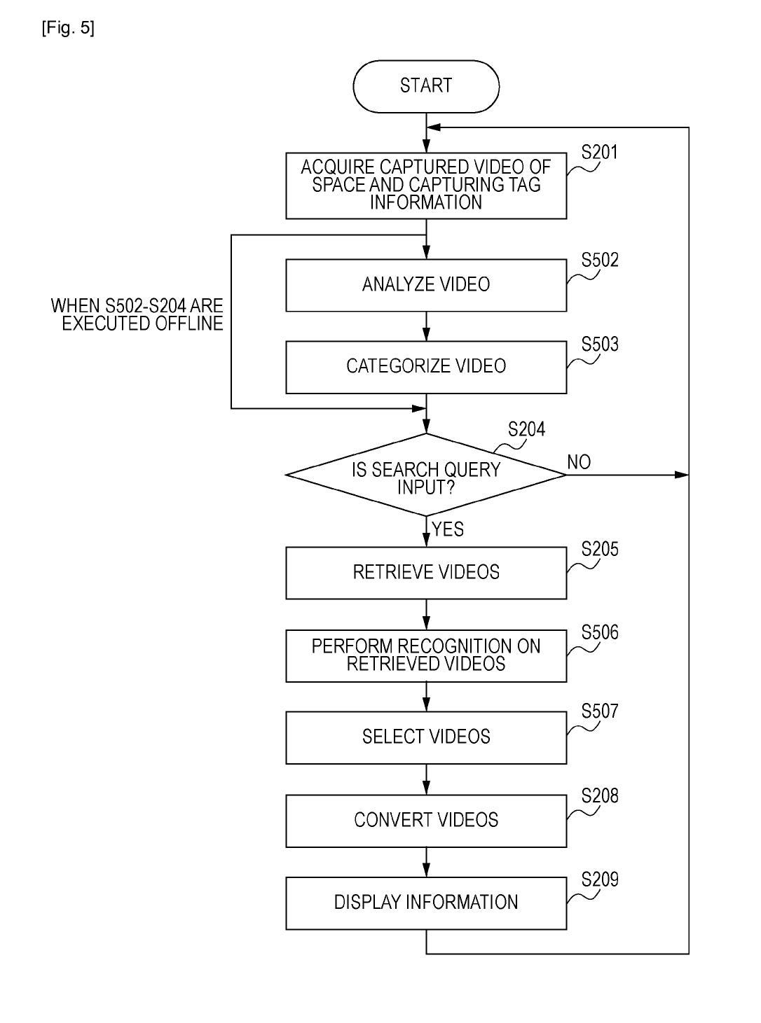

Processing executed by the video information processing apparatus 400 according to this exemplary embodiment will now be described with reference to a flowchart of FIG. 5. A program code according to the flowchart is stored in a memory, such as a RAM or a ROM, in the video information processing apparatus 400 according to this exemplary embodiment, and is read out and executed by a CPU or a MPU.

In STEP S201, the acquiring unit 101 acquires a captured video. The acquiring unit 101 also acquires, as metadata, information regarding a space where the video is captured. For example, the acquisition is performed offline every day or at predetermined intervals. The captured video and the metadata acquired by the acquiring unit 101 are sent to the analyzing unit 103. The process then proceeds to STEP S502.

In STEP S502, the analyzing unit 103 receives the captured video and the metadata output from the acquiring unit 101. The analyzing unit 103 then analyzes the video. The video analysis result and the metadata are sent to the categorizing unit 104-1. The process then proceeds to STEP S503.

In STEP S503, the categorizing unit 104-1 categorizes the captured video into corresponding one or more of a plurality of prepared categories based on the video analysis result and the metadata output from the analyzing unit 103.

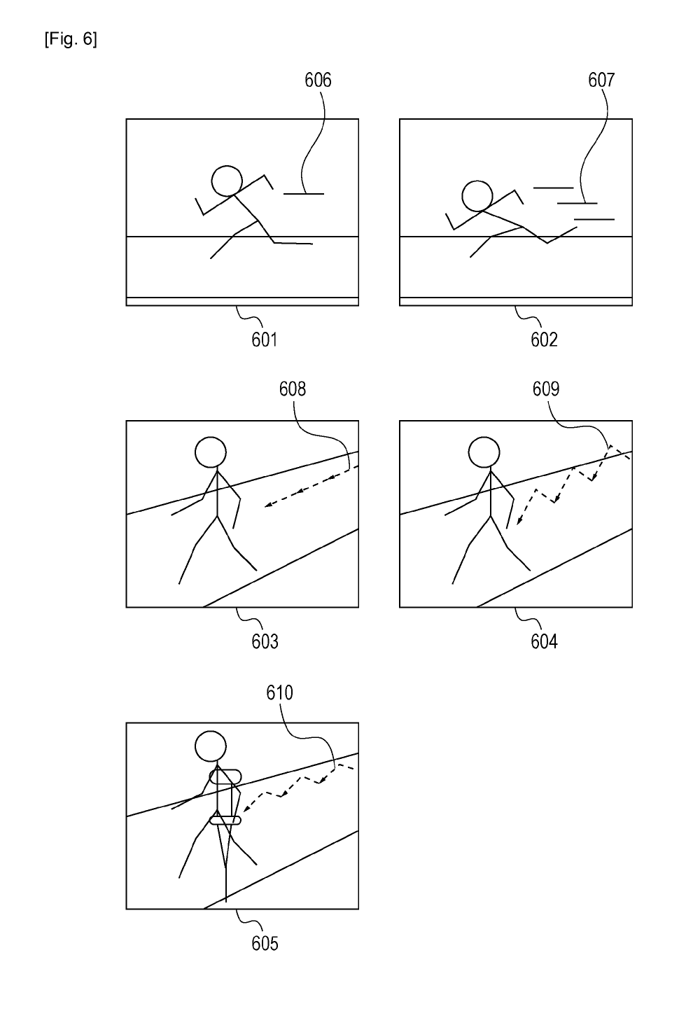

FIG. 6 is a diagram illustrating examples of captured videos in accordance with this exemplary embodiment. More specifically, events “running” 601 and 602, events “walking” 603 and 604, and an event 605 “walking with a stick” are captured. By analyzing each of the captured videos in a way similar to the first exemplary embodiment, movement speeds 606 and 607 and movement paths 608, 609, and 610 can be attached as tag information.

For example, when the categorizing unit 104-1 receives a analysis result “subject movement speed X m/s” and metadata “in the morning” from the analyzing unit 103, the categorizing unit 104-1 categorizes the video received from the analyzing unit 103 into a category “subject movement speed X m/s in the morning”. For example, the videos are categorized into a category “distance between the acquiring unit 101 and the subject in the morning less than or equal to Y m” or a category “subject moving more than or equal to Z m within 10 seconds”.

The determined category serving as new metadata is recorded on the recording medium 107. The process then proceeds to STEP S204.

In STEP S204, the retrieving unit 104-2 determines whether an event query for retrieving captured videos is input. If the input is determined, the process proceeds to STEP S205. Otherwise, the process returns to STEP S201.

In STEP S205, the retrieving unit 104-2 retrieves recorded videos. More specifically, the retrieving unit 104-2 extracts captured videos having the metadata corresponding to the event query. The extracted videos, the corresponding metadata, and the video analysis result are sent to the recognizing unit 102 and the selecting unit 104-3. The process then proceeds to STEP S506.

In STEP S506, the recognizing unit 102 performs qualitative video recognition on a person included in each of the videos sent from the retrieving unit 104-2. The recognition result is sent to the selecting unit 104-3. The process then proceeds to STEP S507.

In STEP S507, based on the metadata of each video and the video recognition result sent from the recognizing unit 102, the selecting unit 104-3 selects a plurality of captured videos from the retrieved videos sent from the retrieving unit 104-2.

For example, an example case where videos of a category “subject movement speed more than or equal to X m/s” are retrieved and sent to the selecting unit 104-3 will be described. The selecting unit 104-3 first selects videos recognized to include “Mr. A”. The selecting unit 104-3 then selects a combination of the videos having as many common recognition results as possible. For example, when three captured videos 603, 604, and 605 have recognition results “walking without a stick”, “walking without a stick”, and “walking with a stick”, respectively, the selecting unit 104-3 selects the videos 603 and 604 with the recognition result “walking without a stick”. If the combination of similar videos (having similar recognition results more than or equal to a predetermined value) are not found, the selecting unit 104-3 selects a plurality of videos having the similar recognition results more than or equal to the predetermined value.

The selected videos and the video analysis result are sent to the generating unit 105. The process then proceeds to STEP S208.

In STEP S208, the generating unit 105 generates video information explicitly indicating a difference in the action included in the videos selected by the selecting unit 104-3. The generated video information is sent to the display unit 106. The process proceeds to STEP S209.

In STEP S209, the display unit 106 displays the video information generated by the generating unit 105 to an observer. The process then returns to STEP S201.

Through the foregoing processing, the video information processing apparatus 400 can extract videos including a given action performed under the same condition from captured videos of a person and select a combination of videos suitably used in visualization of a difference in the action.

### Third Exemplary Embodiment

In the first exemplary embodiment, captured videos are categorized based on a recognition result, the categorized videos are analyzed, and appropriate videos are selected. In the second exemplary embodiment, captured videos are categorized based on an analysis result, the categorized videos are recognized, and appropriate videos are selected. By combining the forgoing methods, captured videos may be categorized based on recognition and analysis results and the categories may be stored as metadata. The categorized videos may be selected after being recognized and analyzed based on the metadata.

### Other Exemplary Embodiment

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CDRW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-286894 filed Dec. 17, 2009, which is hereby incorporated by reference herein in its entirety.

1. A video information processing apparatus comprising:
a recognizing unit configured to recognize an event in a real space in each of a plurality of captured videos of the real space;
a categorizing unit configured to attach metadata regarding each recognized event to the corresponding captured video to categorize the captured video;
a retrieving unit configured to retrieve, based on the attached metadata, a plurality of captured videos of a given event from the categorized captured videos;
an analyzing unit configured to analyze a feature of a movement in each of the plurality of retrieved videos; and
a selecting unit configured to select, based on a difference between the features of the movement analyzed for the retrieved videos, two or more videos from the retrieved videos.

2. A video information processing apparatus comprising:
an analyzing unit configured to analyze a feature of a movement in each of a plurality of captured videos of a real space;
a categorizing unit configured to attach metadata regarding each analyzed feature of the movement to the corresponding captured video to categorize the captured video;
a retrieving unit configured to retrieve a plurality of captured videos based on the attached metadata;
a recognizing unit configured to recognize an event in the real space in each of the plurality of retrieved videos; and
a selecting unit configured to select, based on the event recognized in each of the retrieved videos, two or more captured videos from the retrieved videos.

3. The video information processing apparatus according to claim 1, wherein the recognizing unit recognizes an event regarding an action of a person.

4. The video information processing apparatus according to claim 1, wherein the analyzing unit analyzes a movement speed and a movement trajectory in each of the plurality of captured videos.

5. The video information processing apparatus according to claim 4, wherein the selecting unit extracts two or more captured videos having a difference between the movement speeds larger than a first predetermined value and a difference between the movement trajectories smaller than a second predetermined value or selects two or more captured videos having the difference between the movement speeds smaller than a third predetermined value and the difference between the movement trajectories larger than a fourth predetermined value.

6. The video information processing apparatus according to claim 1, wherein the selecting unit selects two or more videos captured on different dates.

7. The video information processing apparatus according to claim 1, further comprising:
a generating unit configured to generate, based on the selected videos, video information to be displayed on a display unit.

8. The video information processing apparatus according to claim 7, wherein the generating unit superimposes the selected videos on one another to generate the video information.

9. The video information processing apparatus according to claim 8, wherein the generating unit reconstructs each of the selected videos in a three-dimensional virtual space to generate the video information.

10. The video information processing apparatus according to claim 7, wherein the generating unit arranges the selected videos side by side to generate the video information.

11. A video information processing method comprising the steps of:
recognizing an event in a real space in each of a plurality of captured videos of the real space;
attaching metadata regarding each recognized event to the corresponding captured video to categorize the captured video;
retrieving, based on the metadata, a plurality of captured videos of a given event from the categorized captured videos;
analyzing a feature of a movement in each of the plurality of retrieved videos;
selecting, based on a difference between the features of the movement analyzed for the retrieved videos, two or more videos from the retrieved videos; and
generating, based on the selected videos, video information to be displayed.

12. A video information processing method comprising the steps of:
analyzing a feature of a movement in each of a plurality of captured videos of a real space;
attaching metadata regarding each analyze feature of the movement to the corresponding captured video to categorize the captured video;
retrieving a plurality of captured videos based on the attached metadata;
recognizing an event in the real space in each of the plurality of retrieved videos;
selecting, based on the event recognized in each of the retrieved videos, two or more captured videos from the retrieved videos; and
generating, based on the selected videos, video information to be displayed.

13. A program causing a computer to execute each step of the video information processing method according to claim 11.

14. A recording medium storing a program causing a computer to execute each step of the video information processing method according to claim 11.
